(19) United States
(12) Patent Application Publication
(10) Pub. No.: US 2022/0388055 A1
(43) Pub. Date: Dec. 8, 2022

(54) A STEEL CORD CUT END PREPARATION DEVICE AND A WELDING MACHINE FOR WELDING STEEL CORD

(71) Applicant: NV BEKAERT SA, Zwevegem (BE)

(72) Inventors: Lingfeng ZOU, Jiangyin (CN); Guoqing HUANG, Jiangyin (CN); Ming XU, Jiangyin (CN); Junhu LIU, Zwevegem (BE)

(73) Assignee: NV BEKAERT SA, Zwevegem, BE (BE)

(21) Appl. No.: 17/774,304

(22) PCT Filed: Nov. 10, 2020
(86) PCT No.: PCT/EP2020/081637

§ 371 Date: May 4, 2022

(30) Foreign Application Priority Data
Nov. 26, 2019 (CN) 201922059266.4

(51) Int. Cl. B21F 7/00; B21F 11/00; B23K 11/00; B23K 20/00

(52) U.S. Cl. CPC B21F 7/00; B21F 11/00; B23K 11/0026; B23K 20/004; B23K 2101/32

(57) ABSTRACT

The steel cord cut end preparation device comprises a set of clamps for clamping a length of steel cord, a rotating driving unit for driving the clamped length of steel cord to be over-twisted and at least one cutter for cutting the steel cord at the over-twisted portion to make a cut end of steel cord, the steel cord cut end preparation device further comprises a heating unit for heating the clamped length of steel cord and a controller for controlling the heating unit and the rotating driving unit, so that the clamped length of steel cord is heated during, before or after it is over-twisted. By using this device, the steel cord welding success ratio is increased.

### TECHNICAL FIELD

The invention relates to a steel cord cut end preparation device for preparing a cut end of steel cord for welding. The invention also relates to a welding machine comprising the steel cord cut end preparation device.

### BACKGROUND ART

Steel cord is for reinforcing rubber articles, normally it has a very long length, i.e. thousands of meters, and therefore the steel cord is wound on a spool and then delivered to the rubber article makers for the further production. Steel cord is normally made by twisting at least two steel wires together, and this twisting process is the so-called cabling or bunching process. During the twisting process, the steel wire breaks sometimes. Recently in steel cord field one trend is to make the lighter steel cord to save energy consumption, thus the steel wires for steel cord become finer and finer but with higher tensile strength, however, such steel wires break easier during the twisting process.

When a steel wire breaks during the twisting process, the general way of repairing is welding. The welding process includes the following steps: firstly cut the steel cord to make a cut end for welding, secondly put two cut ends together, thirdly weld the two cut ends to connect them together, and finally anneal the weld.

The cut end of steel cord for welding is very important, since the quality of the weld is impacted by the quality of the cut end of steel cord.

Presently the cut end of steel cord is made as follows: over-twisting the steel cord, and then cutting the steel cord at the over-twisted portion to form a steel cord cut end.

JPH02-247081 discloses a weld machine comprising a steel cord cut end preparation device. The cut end of steel cord is made as follows: firstly over-twisting the steel cord, and then cutting the steel cord at the over-twisted portion. The steel cord cut end preparation device comprises a rotary clamp and a stationary clamp for clamping the steel cord, it also comprises a cutter for cutting the steel cord. However, this device is not available for the steel cord consisting of steel wires with super high tensile strength (ST) or above, since the over-twisting on the steel cord consisting of the steel wires with super high tensile strength or above would lead to more fracture of the steel wires, and then the operator must prepare the cut end again in case of steel wire fracture, and this decreases the work efficiency.

### DISCLOSURE OF INVENTION

The primary object of the invention is to solve the problem of the prior art.

One object of the invention is to provide a steel cord cut end preparation device for preparing a cut end of steel cord for welding.

Another object of the invention is to provide a welding machine for welding steel cords.

According to one object of the invention, a steel cord cut end preparation device is provided. The steel cord cut end preparation device comprises a set of clamps for clamping at least one length of steel cord, a rotating driving unit for driving the clamped length of steel cord to be over-twisted and at least one cutter for cutting the steel cord at the over-twisted portion to make a cut end of steel cord and, the steel cord cut end preparation device further comprises a heating unit for heating the clamped length of steel cord and a controller for controlling the heating unit and the rotating driving unit, so that the clamped length of steel cord is heated during, before or after it is over-twisted.

Different from the prior art, the steel cord cut end preparation device has a heating unit for heating the clamped length of steel cord, so that the clamped length of steel cord is heated during, before or after it is over-twisted. By doing this, the invention steel cord cut end preparation device can significantly reduce the fracture problem of the steel wires with super high tensile strength or above led by the over-twisting step for making cut end of steel cord for welding, thereafter more qualified cut ends can be obtained for the steel cord comprising steel wires with super high tensile strength or above, and the steel cord welding success ratio is increased.

According to the invention, “the clamped length of steel cord is heated during, before or after it is over-twisted” means that the sequences of the heating of the steel cord and the over-twisting of the steel cord have various ways. One preferable solution is that the heating is done before and during the over-twisting. Another preferable solution is that the heating is done during the over-twisting (the two operations are synchronized). These preferable solutions can improve the fracture problems of steel wires during the over-twisting of the steel cord very much.

According to the invention, the heating unit is an electrical resistive heating unit. As a preferable solution, the electrical resistive heating unit, the clamped length of steel cord and the corresponding clamps generate a circuit loop when the electrical power is supplied.

As an alternative solution, the heating unit can be an induction-heating unit or even a gas fired heating unit.

Preferably, the heating applied to the clamped length of steel cord is done during the over-twisting, and the heating could be a continuous heating or a dis-continuous heating, while the dis-continuous heating means the heating and non-heating repeat in a pre-determined time period.

According to the invention, the set of clamps comprises at least one rotatable clamp and at least one stationary clamp. Preferably, the at least one rotatable clamp and the at least one stationary clamp are electrical conductive clamps and are connected with the heating unit for electrifying the clamped length of steel cord. The heating unit comprises at least one electrical brush and at least one voltage transformer for providing the electrical voltage or electrical power, wherein the electrical brush is for transmitting the electrical power to the rotatable clamp. Preferably, the set of clamps comprises two rotatable clamps, thereby two cut ends of steel cords can be prepared at the same time, and this improves the work efficiency.

According to the invention, “a set of clamps for clamping at least one length of steel cord” means that one, two or more steel cords with a certain length can be clamped.

As a preferable solution, to save the material and save the cost, the rotatable clamp and/or the stationary clamp comprises an electrical conductive element and a holder for holding the electrical conductive element, and the rotatable clamp or the stationary clamp is connected with the heating unit for electrifying the clamped length of steel cord via the electrical conductive element, so that the electrical conductive element makes the stationary clamp or the rotatable clamp being electrical conductive. The holder provides the main clamping strength. This design achieves a good balance between the electrical conductivity and the clamping strength for a clamp.

Preferably, the electrical conductive element is made of copper, copper alloy, aluminium or aluminium alloy, and the holder is made of iron or iron alloy. The iron or iron alloy material makes the holder being electrical conductive, however, the holder has less electrical conductivity than the electrical conductive element, therefore the electrical conductive element play a major role in the electric conduction for the clamped length of steel cord.

The rotating driving unit may be manually operated as mentioned in the prior art. However, the rotating driving unit is preferably operated automatically. The automatically operated rotating driving unit comprises at least one motor for rotating the at least one rotatable clamp, at least one induction electrical eye for monitoring the number of turns of the rotatable clamp and transferring the signal to the controller. With the rotating driving unit, the over-twisting of the clamped length of steel cord with a determined number of rotating or twisting turn is realized.

The controller is for controlling the rotating turns of over-twisting, heating time, voltage for heating and etc. Depending on the construction of the steel cord, a proper heating time, number of rotating turns and voltage for heating are pre-set in the controller. The working sequences of heating and rotating are also set in the controller, thereby controlling that the heating of the clamped length of steel cord is done during, before or after over-twisting of the clamped length of steel cord.

The cutter may be located between the at least one stationary clamp and at least one rotatable clamp. Alternatively the cutter is located beside the at least one stationary clamp in the direction opposite to the at least one rotatable clamp, and this avoids the damage from the cutter to the clamped length of steel cord during over-twisting.

The cutter can be any one of the existing type of cutter. Preferably, the cutter comprises a first plate and a second plate separately provided with at least one cutter blade, the cutter further comprises a rotating shaft and at least one set of disc springs. The rotating shaft, for example a screw, extends through the first plate and is fixed to the second plate. The disc springs are set between the first plate or the second plate and the cutter blade set correspondingly, so that the compression of the cutter is adjusted by the compression or the release of the disc springs via the rotating of the rotating shaft. This is easier for operating. Preferably, the first plate and the second plate are separately inserted with two cutter blades.

Generally, the over-twisting along the clamped length of the steel cord is inhomogeneous, since the heating along the length of the steel cord is inhomogeneous, and the relatively more heated portion is relatively easier to be over-twisted. Normally, the central portion of the clamped length of steel cord is the relatively more heated portion and thereby the relatively more over-twisted portion, this means the central portion of the clamped length of steel cord is relatively tighter than the end portions that is close to the clamps after being over-twisted. In principle, the relatively more over-twisted portion is preferred for being cut to make a cut end of steel cord without loose. As thus the position of the cutter is pre-set and fixed according to this to ensure the cut is done on the central portion of the clamped length of steel cord which is the relatively over-twisted portion. One finding is that the heating on the clamped length of steel cord is slight and very easily to be influenced and eliminated by the working environment, such as the cold temperature or the wind, the relatively more heated portion of the clamped length of steel cord sometime is out of the central portion, as a result, the relatively more over-twisted portion of the clamped length of steel cord is out of the central portion, and the cut is not on the relatively more over-twisted portion of the clamped length of steel cord due to the fixed position of the cutter. This is not the expectation. To solve the above problem, at least one cover is installed for reducing the heat elimination of the clamped length of steel cord during heating. The clamped length of steel cord is partially or completely accommodated inside the cover during the heating, as thus the heat elimination of the clamped length of steel cord during heating is reduced. As a preferable solution, the cover is a tube with a hollow along its length, wherein one end of the tube is connected with the clamp preferably the rotatable clamp, and at least the two-thirds of the clamped length of steel cord is accommodated inside the hollow of the tube during the heating.

According to another aspect of the invention, a welding machine is provided. The welding machine comprises a welding device for welding the cut ends of steel cords, a steel cord cut end preparation device and/or an annealing device for annealing the weld, the steel cord cut end preparation device comprises a set of clamps for clamping at least one length of steel cord, a rotating driving unit for driving the clamped length of steel cord to be over-twisted and at least one cutter for cutting the steel cord at the over-twisted portion to make a cut end of steel cord and, the steel cord cut end preparation device further comprises a heating unit for heating the clamped length of steel cord and a controller for controlling the heating unit and the rotating driving unit, so that the clamped length of steel cord is heated during, before or after it is over-twisted.

### BRIEF DESCRIPTION OF FIGURES IN THE DRAWINGS

FIG. 1a-1c shows one embodiment of the steel cord cut end preparation device.

FIG. 2a-2b shows the cutter of the steel cord cut end preparation device.

FIG. 3a-3b shows the cover of the steel cord cut end preparation device.

### MODE(S) FOR CARRYING OUT THE INVENTION

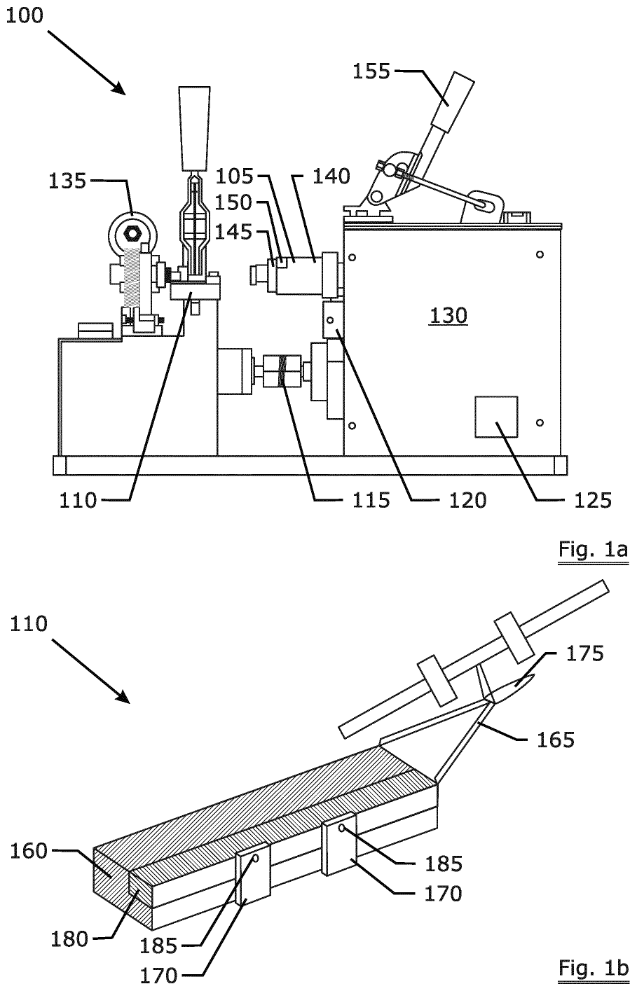

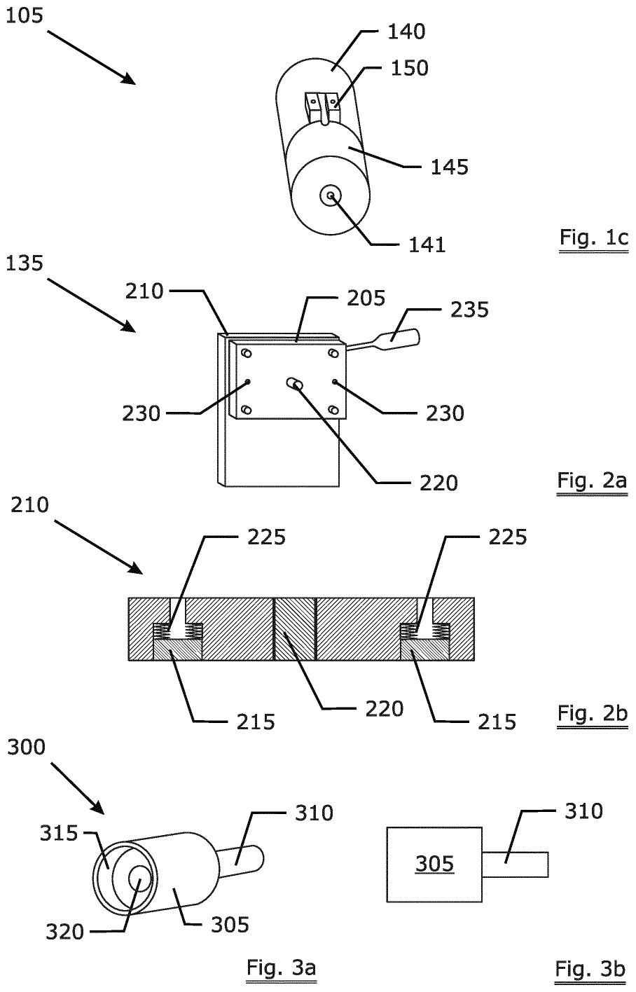

FIG. 1a-1c shows one embodiment of the steel cord cut end preparation device. The steel cord cut end preparation device 100 comprises a set of clamps, one cutter, a rotating driving unit and a heating unit.

The set of clamps comprises two rotatable clamps 105 and one stationary clamp 110. Each rotatable clamp 105 has a movable clamping head 145, a first electrical conductive element 140 and a second electrical conductive element 150. Two rotatable clamps 105 are operated by a first handle 155. The movable clamping head 145 is set with a first through hole 141. The second electrical conductive element 150 is fixed on the first electrical conductive element 140 and connected with the first through hole 141. The steel cord is clamped via the engagement of the movable clamping head 145 and the second electrical conductive element 140 by pressing the first handle 155. The stationary clamp 110 has a holder and a third electrical conductive element 180. The holder has a fixed down part 160, a rotatable upper part 165 and two guiding elements 170, and the rotatable upper part 165 is set with a second handle 175. The third electrical conductive element 180 is fixed on the fixed down part 160. Each of the guiding elements 170 has a second through hole 185 with a bottom in line with the surface of the third electrical conductive element 180. The steel cord is clamped via the engagement of the fixed down part 160 and the rotatable upper part 165 by pressing the second handle 175.

The rotating driving unit is located inside the cabinet 130, and it comprises a motor, two rotating shafts and one belt for connecting the motor and the rotating shafts. The two rotating shafts are connecting with the two rotatable clamps 105. The rotating driving unit further comprises an induction electrical eye for monitoring the rotating turns of the rotatable clamp and transferring the corresponding signal to the controller for controlling the rotating driving unit.

The heating unit for electrifying and heating the clamped length of steel cord comprises two electrical brushes 120 for transmitting the electrical power to the rotatable clamps 105 and at least one voltage transformer 115 for providing the proper voltage. Each electrical brush 120 is electrically connected with one of the first electrical conductive element 140. When the heating unit works, the electrical power is supplied from the voltage transformer 115 to the electrical brush 120, and then to the first electrical conductive element 140, and then to the second electrical conductive element 150, and then to the clamped length of steel cord, and then to the third electrical conductive element 180, thereafter the clamped length of steel cord is heated.

The controller is realized by a control panel 125 with a number of pre-set programs. The control panel 125 is installed on the cabinet 130 for easier operation. Depending on the constructions of the steel cords, a proper heating time, number of rotating turns, voltage of heating or the working sequences of heating and rotating is pre-set via the control panel 125.

FIG. 2a shows the cutter, FIG. 2b shows the cross-section the second plate of the cutter, FIG. 2b shows the part of the screw 220 in the second plate 210. The cutter 135 comprises a first plate 205 and a second plate 210 separately inserted with two cutter blades 215, the cutter 135 further comprises a screw 220 extending through the first plate 205 and fixed with the second plate 210 and the disc springs 225 set between each cutter blade 215 and the second plate 210. When rotating the screw 220 forward or backward, the disc springs 225 are compressed or released, thereby the connection between the second plate 210 and the cutter blades 215 becomes more close or more loose, thereby the compression of the cutter 135 is adjusted. The cutter is set with two third through holes 230 for guiding the steel cords. The cutter has a third handle 235 for operating. Depends on the constructions of the steel cords, a proper cutter compression is pre-determined.

The first through holes 141, the second through holes 185 and the third through holes 230 are in the same horizontal level.

The cutter 135 is located beside the stationary clamp 110 in the direction opposite to the rotatable clamps 105.

When a steel cord is detected with one or more broken steel wires, the portion of steel cord with broken steel wire is cut away thereby to have two separate steel cords with two irregular ends, and then each of the two irregular ends of steel cords is pushed to go through the third through hole 230 in the cutter 135, the second through hole 185 of the holder and the first through hole 141 of the movable clamping head in sequence, and then a length of the steel cord is clamped by the rotatable clamp 105 and the stationary clamp 110 by pressing down the first handle 155 and the second handle 175 in sequence. The first through hole 141 is oblique with a certain angle, so that the steel cord is bent thereby forming a hook at its end portion at the rotatable clamp 105.

Then the motor is activated, and the rotatable clamp 105 rotates in a pre-set number of turns, whereby the clamped length of steel cord is over-twisted. For sure the rotating direction shall be the same as the twist direction of the steel cord itself to ensure the clamped length of steel cord is over-twisted but not un-twisted. When the induction electrical eye detects that the pre-set number of rotating turns is achieved, the controller will give a signal to the motor, and then the motor stops working. The heating unit works according to the pre-setting, thereafter the clamped length of steel cord is heated during, before or after it is over-twisted by the heating unit. When the over-twisting and heating of the steel cord are finished, each of the steel cords is pulled out from the first through hole 141 until the steel cord is stuck at the second through hole 185 of the stationary clamp 110 because of the existing of the hook. Then the steel cord is cut at the over-twisted portion by pressing down the third handle 235 of the cutter 135.

A weld quality comparison test is done between the invention device and prior art. Table 1 summarizes the test result. The test is to know if the weld of the steel cord passes the breaking load measurement that requires the breaking load of the weld is at least 40% of the minimum breaking load of the steel cord as measured in a standard GB/T11181-2016.

TABLE 1

| | Invention 1 | Invention 2 | Invention 3 | Invention 4 | Invention 5 | Prior art |
|---|---|---|---|---|---|---|
| Heating during | yes | yes | yes | no | no | no |
| over-twisting | | | | | | |
| Heating before | yes | yes | no | yes | no | no |
| over-twisting | | | | | | |
| Heating after | no | yes | no | no | yes | no |
| over-twisting | | | | | | |
| steel cord | 2 × 1 | 2 × 1 | 2 × 1 | 2 × 1 | 2 × 1 | 2 × 1 |
| construction | | | | | | |
| Steel wire | 0.3 | 0.3 | 0.3 | 0.3 | 0.3 | 0.3 |
| diameter (mm) | | | | | | |
| Tensile strength of | ST | ST | ST | ST | ST | ST |
| the steel wire of | | | | | | |
| steel cord (MPa) | | | | | | |
| Welding success ratio | 80% | 90% | 50% | 60% | 40% | 30% |

Welding success ratio means in ten samples the number of weld of the steel cord passing the breaking load measurement.

From the table, it is clear that the invention device can increase the welding success ratio significantly.

As a preferably solution, two covers are used for reducing the heat elimination of the clamped length of steel cord during heating. Each of the covers is connected with one rotatable clamp 105. The cover is shown in FIG. 3a-3b. The cover is a tube 300. The tube 300 has two parts 305 and 310, the part 305 has a hollow 315 with bigger diameter for connecting with the rotatable clamp 105 and accommodating the steel cord, and the part 310 has a hollow 320 with smaller diameter for accommodating the steel cord. The two parts 305 and 310 are integral. The tube 300 has a certain length to make sure that at least two-thirds of the clamped length of steel cord is accommodated inside the tube 300 during heating. Considering the connection with other elements, the tube 300 can be set with hole or slot if any.

A second embodiment is a welding machine for welding steel cords, it comprises a welding device for welding, a steel cord cut end preparation device 100 and annealing device for annealing the weld.

1-12. (canceled)

13. A steel cord cut end preparation device, comprising a set of clamps for clamping at least one length of steel cord, a rotating driving unit for driving said clamped length of steel cord to be over-twisted and at least one cutter for cutting the steel cord at the over-twisted portion to make a cut end of steel cord, wherein said steel cord cut end preparation device further comprises a heating unit for heating the clamped length of steel cord and a controller for controlling said heating unit and said rotating driving unit.

14. The steel cord cut end preparation device as claimed in claim 13, wherein said heating unit is an electrical resistive heating unit.

15. The steel cord cut end preparation device as claimed in claim 14, wherein said a set of clamps comprises at least one rotatable clamp and at least one stationary clamp, said at least one rotatable clamp and said at least one stationary clamp are electrical conductive clamps and are connected with said heating unit for electrifying the clamped length of steel cord, said heating unit comprises at least one electrical brush for transmitting the electrical power to said clamps and at least one voltage transformer.

16. The steel cord cut end preparation device as claimed in claim 15, wherein said rotatable clamp and/or said stationary clamp comprises an electrical conductive element and a holder for holding said electrical conductive element, said electrical conductive element is connected with said heating unit for electrifying the clamped length of steel cord.

17. The steel cord cut end preparation device as claimed in claim 16, wherein said electrical conductive element is made of copper, copper alloy, aluminium or aluminium alloy, and said holder is made of iron or iron alloy.

18. The steel cord cut end preparation device as claimed in claim 15, wherein said rotating driving unit comprises a motor for rotating said at least one rotatable clamp and at least one induction electrical eye for monitoring the rotating turns of said rotatable clamp and transferring the signal to said controller.

19. The steel cord cut end preparation device as claimed in claim 15, wherein said cutter is located beside said at least one stationary clamp in the direction opposite to said at least one rotatable clamp.

20. The steel cord cut end preparation device as claimed in claim 13, wherein said cutter comprises a first plate and a second plate separately inserted with at least one cutter blade, said cutter further comprises a rotating shaft extending through said first plate and is fixed to said second plate, the disc springs are set between said first plate or said second plate and the corresponding cutter blade.

21. The steel cord cut end preparation device as claimed in claim 13, wherein said steel cord cut end preparation device comprises at least one cover for reducing the heat elimination of the clamped length of steel cord during heating.

22. The steel cord cut end preparation device as claimed in claim 21, wherein said cover is a tube connecting with one of said a set of clamps, said tube is hollow for accommodating the clamped length of steel cord partially or completely during heating.

23. The steel cord cut end preparation device as claimed in claim 22, wherein said tube has a length for accommodating at least two-thirds of the clamped length of steel cord during heating.

24. The welding machine for welding steel cords, said welding machine comprising a welding device, a steel cord cut end preparation device and/or an annealing device, wherein said steel cord cut end preparation device is as claimed in claim 13.
